(19) United States
(12) Patent Application Publication
(10) Pub. No.: US 2008/0095673 A1
(43) Pub. Date: Apr. 24, 2008

(54) MICROPLATE WITH FEWER PERIPHERAL ARTIFACTS

(76) Inventor: Lin Xu, Saint Louis, MO (US)

Correspondence Address: GUOLIN WEN, 8320 DELCREST DR. 2A, SAINT LOUIS, MO, 63124, US

(21) Appl. No.: 11/875,906

(22) Filed: Oct. 21, 2007

Related U.S. Application Data
(60) Provisional application No. 60/862,419, filed on Oct. 20, 2006.

(51) Int. Cl. B01L 3/00

(52) U.S. Cl. 422/102

(57) ABSTRACT

The current invention relates to an improved microplate. The microplate is characterized by modified quadrilateral edges, which bring less artificially induced inaccuracies in peripheral wells, especially in corner wells. Preferably, the microplate possesses a bottom that is elongated to cover the non-experimental slots. The microplate might further comprise sham wells.

### CROSS-REFERENCE TO RELATED APPLICATIONS

This application is claiming the benefit of U.S. provisional patent application Ser. No. 60/862,419, filed Oct. 20, 2006 by the present inventor.

### FEDERALLY SPONSORED RESEARCH

Not Applicable

### SEQUENCE LISTING OR PROGRAM

Not Applicable

### BACKGROUND

1. Field of the Invention

The present invention relates to a micro-well sample plate which is commonly referred to as a microplate and which is used to hold a large number of samples in a standardized format. More specifically, the present invention relates to a microplate with modified quadrilateral edges, which bring less artificially induced inaccuracies in peripheral wells, especially in corner wells.

2. Prior Art

Microplates are widely used for storing, filtering, incubating and detecting samples in chemical experiments, biological assays, medical tests and the like. For example, a microplate might be used as micro-containers to store, filter, prepare, or incubate multiplicate samples in different wells by a parallel way, and as well, a microplate can be used to conduct relatively tiny volume cell cultures in vitro. The sample filled microplate might eventually be subject to specific measuring methods like Enzyme Linked Immuno-Sorbent Assay (ELISA) to analyze its contents qualitatively and/or quantitatively. The most apparent advantage related to the microplate is a set of trace reactions can be conducted simultaneously.

A typical microplate based on prior arts usually comprises the following: an experimental unit 1 which consists of a plurality of micro-wells 3 in some cases numbering 48, 96, 384, or 1536, and a bottom 4 enabling a complete closure to all micro-wells from underneath; a supporting base 2 consisting of four side-walls 5 and an upper platform 6 that is able to connect the said four side-walls 5 with the said micro-wells 3 from above by known techniques like welding, meanwhile forming four non-experimental slots 7 underneath the platform 6 between the said experimental unit 1 and the said side-walls 5; the said side-wall might further comprise a bottom outside flange 8.

As most microplate operators may know, an expectation when using a microplate in laboratory applications is that this sort of microplate should be able to simultaneously handle dozens of samples it contains and keep all samples going under the same protocol. To realize this, first of all, it is necessary for an operator or operating machine to feed each micro-well with exactly the same quantity of reagents whenever it needs per protocol; Secondly, each micro-well must be treated exactly under the same surrounding situations, generally inclusive of temperature, air ventilation, humidity and light exposure; At last, all micro-wells within a plate should be physically the same if considering its supramolecule binding ability, and bottom evenness, wall straightness, light penetration, and heat transmission when compared to each other. In shorts, the micro-wells have to be furnished exactly in the same way.

For better explanation purpose, in this specification, the accuracy of reagent transfer whose change may affect final results is described as one of the metrical factors. And the surrounding situations such as temperature, air ventilation, humidity, and light exposure are defined by a holistic term as environmental factors. And supramolecule-binding ability, and bottom evenness, wall straightness, light penetration, and heat transmission are defined as physical factors in this regard.

It is fortunate that depending on current pipette technologies the most accurate liquid transfer can be reached with a skillful technician and the above mentioned concerns over metrical factors could be solved very well.

However, there are some considerable limitations related to current commercially available microplates due to the influences of surrounding factors. For example, when a 96-well microplate based on prior arts is moved from 4° C. to 37° C. during an incubation process, ambient air will immediately enter the nonexperimental slots 7, and then peripheral wells 9 will have temperatures increased faster than internal wells 10; And absolutely, four corner wells 11 have the first preference of thermal increase. The same temperature changing disparity will apply when it is cooling down. As a result, if the experiment itself is sensitive to temperature changes, artificially affected results will be obtained at peripheral wells, especially at corner wells. In general, surrounding factors as above exemplified by the temperature, will have peripheral preference because of the non-experimental slots in a traditional microplate, which eventually induce the peripheral artifacts.

Peripheral artifacts also appear when using micro-wells to store liquid samples. The wells at edges and corners are surrounded differently compared to internal wells, so that the former will have apparent dissimilarity in air ventilation and heat transmission. In specifics, the peripheral wells are subject to a different air-ventilating pattern by which volatile solvents evaporate faster than in internal wells. As a result, samples stored in the peripheral wells, especially the corner wells, will be more or less concentrated after a long-term storage. This peripheral artifact still exists even though the microplate is sealed during storage. A sticky sealing film used to cover the microplate is often stuck well at peripheral edges even after a long-time storage, but might be easy to pop up in the middle. This will bring a different air pattern at peripheral wells, which induces artifacts.

And physical factors sometimes effect together with surrounding factor to exaggerate incomparable performances between peripheral wells and internal wells within a conventional microplate. For example, of flat-bottom microplates, bottom evenness is currently under concerns in most of microplate manufacturers and operators. Due to the current design of conventional microplates, pressures and tensions are not as evenly distributed to edges and corners of the bottom as to the internal areas of the bottom. As a result, the plate will be finished with an invisibly curly bottom when it eventually comes out of a factory. This kind of uneven bottom might go along with problems in molecule binding ability, biased penetration and/or reflection of light, all of which might affect later-on spectrophotometric measurements. And the most likely problematic wells should be at edges and/or corners. So the peripheral artifacts found in a conventional microplate might also be owing to physical factors.

Nevertheless, even if manufacturing a totally even bottom is no longer a problem, there are still some visible differences between peripheral wells and internal wells. An internal well is surrounded by other eight wells which may absorb and bounce back light interferences, but a peripheral well is not. As a result, peripheral wells may have a different pattern of light interferences, so as to earn some artifacts when the wells are subject to a spectrophotometric measurement that is sensitive to the surrounding light exposure. For better explanation purpose, these artifacts will be described as the disparity of light exposure in this specification.

It is inevitable that the above-mentioned limitations have caused some inaccurate experimental results, for example, increase or decrease in spectrophotometric reading values, in the conventional microplates. Accordingly, there exists a need for a microplate which overcomes the above noted drawbacks associated with existing techniques.

### SUMMARY

In this specification, some specific terms are defined as follows unless otherwise indicated.

“Peripheral wells” or “the first series of wells” is defined as a set of wells consisting of the first row, the last row, the first column, and the last column of regular micro-wells, exclusive of extra sham wells, in a microplate. “Internal wells”, or “internal experimental wells” is defined as all other wells within a microplate that are encircled by the “peripheral wells”. Both “peripheral wells” and “internal wells” are regular micro-wells.

“Sham wells” is defined as the wells from which any final experimental results obtained are predicted to be useless, no matter whether the said sham wells are used to host an assay, or they are just left blank without an assay. Once sham wells are in the regular micro-wells area, they are called “regular sham wells”. “Extra sham wells” is defined as some excessive wells existing in a microplate other than regular micro-wells, and these excessive wells are used as sham wells.

“Peripheral artifacts”, “lateral artifacts”, “quadrilateral artifacts”, or “edge artifacts” is defined as artificially induced difference(s) of experimental results specifically stemming from “peripheral wells” or “lateral wells” other than internal experimental wells. These artifacts are usually owing to disparities of thermal receptance, light exposure, and/or liquid evaporation between “peripheral wells” and “internal wells”. “Corner artifacts” is defined as artifacts specifically resulting from “corner wells” that are used to host an assay.

“Slot area” is defined as an area that is supposed to be a slot (slots) in there, but actually might be modified to a non-slot structure.

The present invention has been made to solve the problems noted above and provide a microplate that has fewer artifacts at peripheral wells, especially at corner wells.

A primary object of the invention is to provide a microplate eliminating the non-experimental slots that may avail physical differences, such as the thermal preference, at peripheral wells, especially at corner wells.

A second object of the invention is to provide a microplate able to retard some of the surrounding influences, i.e. thermal transmission, from the ambience via side-walls sideward to the experimental unit, and/or accelerate thermal transmission from the ambience upward and/or downward to the experimental unit.

A third object of the invention is to provide a microplate which achieves the alleviation or elimination of disparity of light interferences at peripheral wells compared to internal wells.

Other objects and advantages of the present invention will become apparent upon reading the following detailed description and upon reference to the accompanying drawings.

To realize the foregoing objects, a microplate according to the present invention, comprising a supporting base and an experimental unit as in a conventional microplate, possesses further improvements.

In a preferred embodiment, a microplate according to the present invention possesses an elongated bottom to cover, weld, and close from underneath not only all the micro-wells as in a conventional microplate, but also the non-experimental slots area until it reaches and welds into the flanges of side-walls.

In another preferred embodiment, a microplate according to the present invention further possesses enhancement(s) at the side-wall; the enhanced side-walls may retard some of the surrounding disparities, like the thermal preference, at peripheral wells.

In still another preferred embodiment, the microplate according to the present invention further possesses single or multiple air-through notch(es) at bottom outside flanges of side-walls, enabling air to flow through the lower ambience.

In a further preferred embodiment, the microplate according to the present invention further comprises sham wells, either complete or incomplete, between the side-walls and the experimental unit; the said sham wells are available or not available for loading samples.

In an alternative preferred embodiment, the microplate according to the present invention is almost equivalent to a conventional microplate, but co-packaged with a separate or affixed sheet informing microplate users of the artifacts of peripheral wells, the associated unreliability, and some preventive ways thereof.

Other preferred embodiments of the present invention will become apparent upon reading the following detailed description and upon reference to the accompanying drawings.

### DRAWINGS—FIGURES

FIG. 1A is a perspective view of a conventional microplate, also showing a partial sectional view of Row H;

FIG. 1B is a top view of a conventional microplate, showing peripheral wells, corner wells, and internal wells;

FIG. 2A is a magnified partial sectional view of a conventional microplate, showing section A-A′ of FIG. 1A;

FIG. 2B is a magnified partial sectional view, showing the same section as in FIG. 2A, of an embodiment of the microplate according to the present invention possessing an elongation of the bottom;

FIG. 2C is a magnified partial sectional view, showing the same section as in FIG. 2A, of an embodiment of the microplate according to the present invention possessing an outer layer of the peripheral well wall;

FIG. 2D is a magnified partial sectional view, showing the same section of a microplate as in FIG. 2A, of an embodiment of the microplate according to the present invention possessing extra sham wells;

FIG. 2E is a magnified partial sectional view, showing the same section of a microplate as in FIG. 2A, of an embodiment of the microplate according to the present invention possessing extra sham wells with upper closure;

FIG. 3 is a side view of an embodiment of the microplate according to the present invention, showing notches at bottom outside flange;

FIG. 4A is a top view of an embodiment of the microplate according to the present invention, showing extra sham wells;

FIG. 4B is a top view of another embodiment of the microplate according to the present invention, showing regular sham wells;

Although all drawings in this specification are illustrated with a flat bottom, it is understood that any other formats of well bottom are also applicable, such as round bottom, V-shape bottom, conical bottom, pyramid-shape bottom, etc.

In general, all specific drawings herein are intended to exemplify the current invention so as to make the invention better understandable. They are not intended to limit the invention within its scope disclosed. On the contrary, any possible modifications and variations based on the spirit and scope of the invention will be covered as defined by the claims.

### DRAWINGS—NUMERALS

1. Experimental unit

2. Supporting base

3. Micro-wells

4. Bottom

5. Side-walls

6. Upper platform

7. Nonexperimental slots

8. Bottom outside flanges

9. Peripheral wells

10. Internal wells

11. Corner well

12. Peripheral well-walls

13. Bottom elongation

14. Cavity

15. Side-wall projection

16. Air-through notches

17. Bottom line

18. Bottom outside flanges

19. Sham wells

20. Complete sham wells

21. Incomplete sham wells

### DETAILED DESCRIPTION

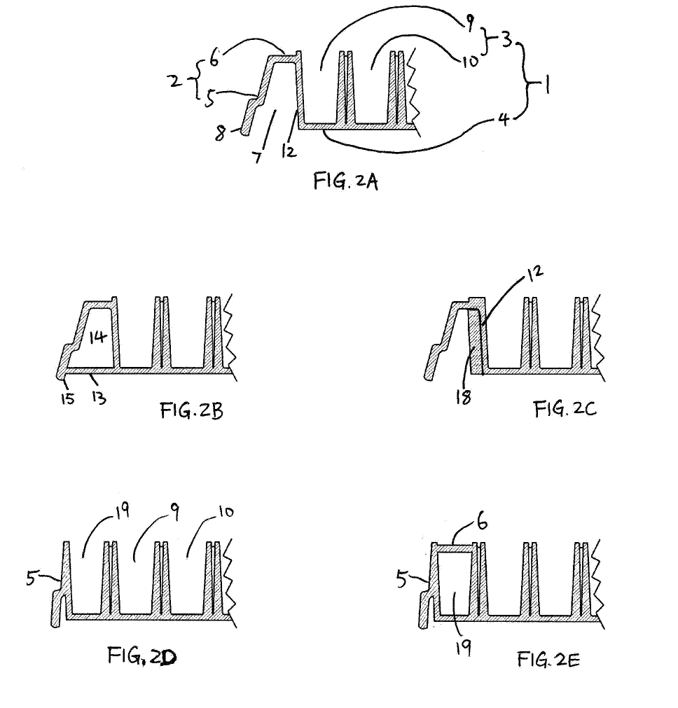

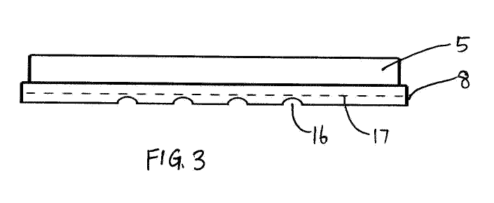

### Preferred Embodiment 1—FIGS. 2B and 3

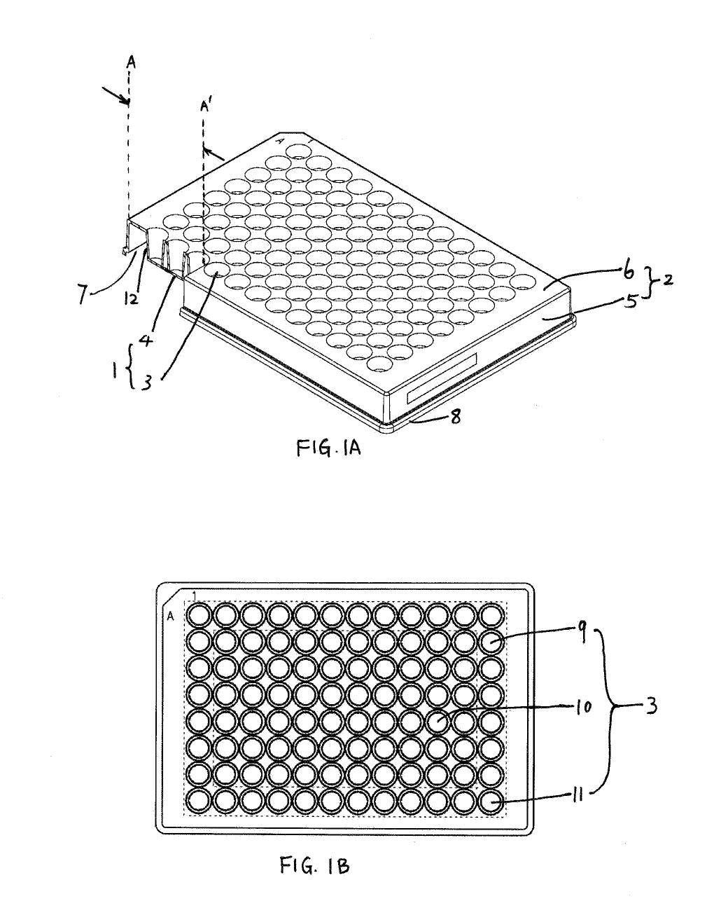

FIG. 1A illustrates a typical microplate based on prior arts that usually comprises the following: 1) an experimental unit 1 which consists of a plurality of micro-wells 3, in some cases numbering 48, 96, 384, or 1536, and a bottom 4 enabling a complete closure to all micro-wells from underneath; and 2) a supporting base 2 consisting of four side-walls 5 and an upper platform 6 that is able to connect the said four side-walls with the said micro-wells from above by known techniques like welding. The said side-wall 5 further comprises a bottom outside flange 8. The said upper platform 6 of a microplate covers the area between side-walls 5 and peripheral well-walls. And in our embodiments the upper platform is preferred to further cover the areas in between micro-wells.

As best seen in FIG. 2A, there exist four nonexperimental slots 7 between the side-walls 5 and the experimental unit 1. The four nonexperimental slots 7 are connected end to end into a rectangular shape if viewed from bottom. These nonexperimental slots 7 are closed by the upper platform 6 on top, but are open to the ambience on bottom. That means the air within the slots 7 is readily refreshable by outside ambient air. Instead, ambient air between internal wells 10 is less refreshable, especially when the microplate is covered by a lid or a film. Apparently, the peripheral wells 9, with peripheral well-walls 12 adjacent to the nonexperimental slots 7, will be bathed in more movable ambient air than internal wells 10 are. As a result, the peripheral wells 9, especially the corner wells 11, are more readily affected by the influences of surrounding factors. For example, when a conventional microplate is undergoing a higher temperature incubation, the peripheral wells 9 will have more chances to get in touch with higher temperature ambience at the beginning, so as to increase in situ temperature temporarily faster than internal wells 10; this is indicated as peripheral thermal preference, which can cause some artificially affected results at peripheral wells 9, especially at corner wells 11 in a temperature-sensitive assay. And absolutely, it is due to the non-experimental slots 7 within the plate.

By comparison, FIG. 2B illustrates a preferred embodiment of the microplate according to the present invention possesses a bottom elongation 13 that is able to cover, weld, and close from underneath not only all the micro-wells 3 as in a conventional microplate, but also the non-experimental slots area until the said bottom elongation reaches and welds into the flanges 8 of side-walls 5. In this embodiment, the non-experimental slots area between the side-walls and the experimental unit are closed on bottom by the elongation 13 of the bottom. And the whole bottom of the microplate will look like an entire structure with rims of side-wall projection 15 in around but without any open rectangular slots. Basically, this will also close out the influence of some surrounding factors which for example might cause the peripheral thermal preference eventually.

One apparent advantage of this embodiment is, because of the elongation 13 of the bottom 4, the disparity of pressures and tensions which was haunting the edges and corners during manufacturing processes and which was considered to be the cause of bottom unevenness, especially unevenness at edges and corners, will affect the elongation 13 area instead; and this will at least help the regular experimentable bottom area be evener.

Although the preferred embodiment according to the current invention is illustrated with a flat bottom, it is understood that any other formats of well bottom are also applicable, such as round bottom, V-shape bottom, conical bottom, pyramid-shape bottom, etc.

In the same preferred embodiment, there will be a cavity 14 formed due to the under-closure of a non-experimental slot area. This cavity 14 might be left empty, or completely/partially stuffed.

In a further preferred embodiment, a microplate according to the present invention further possesses four side-walls able to retard some of the surrounding influences, like the thermal preference, at peripheral wells. Preferably, the side-wall is enhanced by increasing its thickness. The thickness of the side-wall, either uniform or not, is preferred to be one to three times more than whatever it is on the counterpart of a conventional microplate. And it is more preferred that the thickness is two times more than a conventional one. The thicker side-walls are able to retard or eliminate some of the surrounding influences, i.e. thermal transmission, from the ambience via side-walls sideward to the experimental unit. As a matter of fact, thermal transmission from the ambience upward and/or downward to the experimental unit is not affected.

Preferably, the said side-wall is further subject to some post-casting treatments, such as carving, etching, finishing, painting, coloring, labeling etc.

Alternatively to the increased thickness of side-walls, side-walls are enhanced by attaching a layer that is able to mask some disparities of the surrounding influences, like the light exposure, at peripheral wells; For one example, the said layer is made of one of some known light-masking materials to prevent the light exposure; The said material can be different from the materials used to make other parts of the microplate. For another example, the said layer is subject to some post-casting treatments, such as carving, etching, finishing, painting, coloring, labeling etc. to prevent the light exposure.

In an additionally further preferred embodiment, the microplate according to the present invention further possesses single or multiple air-through notches 16 at bottom outside flanges 8 of side-walls 5, accelerating air-flowing through the lower ambience and thermal transmission from the ambience upward to the experimental unit. As best shown in FIG. 3, the said notches are below the level of bottom line 17.

### Preferred Embodiment 2—FIG. 2C

A preferred embodiment of the microplate according to the present invention possesses peripheral well-walls able to retard some of the surrounding influences, like the thermal preference, at peripheral wells.

Preferably, the peripheral well-wall is enhanced by increasing its thickness. The thickness of the peripheral well-wall, in a uniform format, is preferred to be one to three times more than a normal thickness of internal well-walls. A more preferred thickness is two times a normal thickness of internal well-walls. The thicker peripheral well-walls are able to retard or eliminate some of the surrounding influences, i.e. thermal transmission, from the ambience via peripheral well-walls sideward to the internal wells. As a matter of fact, thermal transmission from the ambience upward and/or downward to the experimental unit is not affected. Alternatively, turning over to FIG. 2C, the peripheral well-wall 12 is consolidated by attaching an outer layer 18 that is able to mask some of the surrounding disparities, like the light exposure, at peripheral wells; For one example, the said layer 18 is made of one of some known light-masking materials to prevent the light exposure; The said material can be different from the materials used to make other parts of the microplate. For another example, the said layer 18 is subject to some post-casting treatments, such as carving, etching, finishing, painting, coloring, labeling etc. to prevent the light exposure.

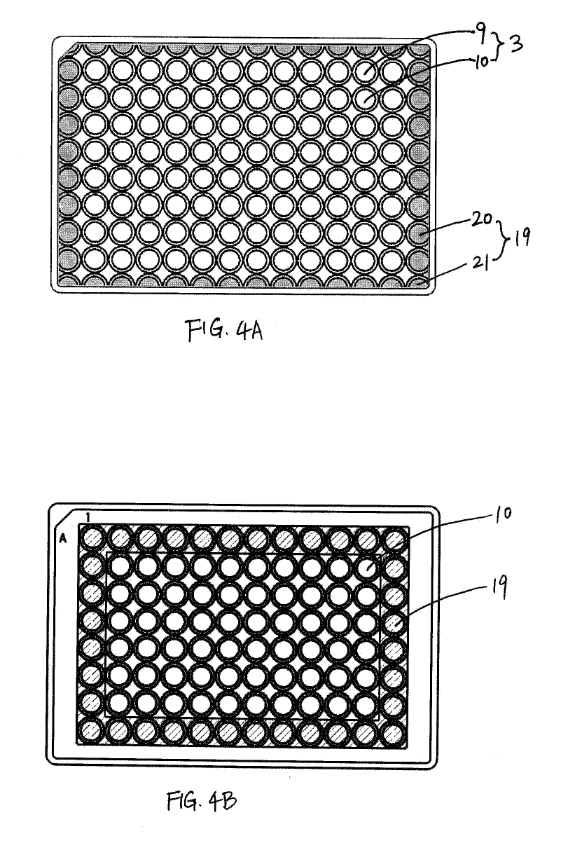

### Preferred Embodiment 3—FIGS. 4A, 4B, 2D, 2E

FIG. 4 illustrates an additional preferred embodiment of the microplate according to the present invention that further comprises sham wells 19, in a format of either complete sham well 20 or incomplete sham well 21; The said sham wells can occupy the nonexperimental slots area between the side-walls 5 and the experimental unit 1, or the peripheral wells 9 in the experimental unit 1, or both; the said sham wells are available or not available for loading samples.

Sham wells are defined as the wells from which any final experimental results obtained are predicted to be useless, no matter whether the said sham wells are used to host an assay, or they are just left blank without an assay.

The said sham wells are manufactured by the same way that an internal well 10 is made. Because of the limiting space, a sham well might be either a complete sham well 20 like an internal well, or an incomplete sham well 21 with laterally cleavage. The sham well might be equal to, or less than an internal well 10 in size. The cavity of a sham well can be partially, fully, or neither stuffed.

As best shown in FIG. 4B, for the layout of the said sham wells in the microplate, it is preferred to be on the peripheral wells 9 in the experimental unit 1, and meanwhile allows this microplate keeping the same as a standard microplate regarding the presence of nonexperimental slots, the number of total wells, and the simplicity of side-walls etc. In this case, the said sham wells are called regular sham wells. For particular exemplification purpose, if a standard microplate has ninety-six wells, the microplate according to the present invention also has ninety-six wells in total, divided into sixty internal wells 10 and thirty-six sham wells 19.

And it is also preferred for the said sham wells 19 to occupy the nonexperimental slots area between the side-walls and the non-experimental slots, as shown in FIG. 4A; And in this case, the microplate has extra sham wells around the peripheral wells 9 and internal wells 1 0, wherein the regular micro-wells number the same as in a conventional microplate. For particular exemplification purpose, if a standard microplate has ninety-six wells, the microplate according to the present invention has ninety-six micro-wells 3 too, plus forty-four extra sham wells 19, that is, one hundred and forty wells in total.

A further modification hereinwith is that sham wells consist of both the said extra sham wells and the said regular sham wells.

FIG. 2D and FIG. 2E individually illustrate two modifications related to this additional preferred embodiment of the microplate possessing sham wells 19. The said sham wells can be covered by the upper platform, which makes them not available to host an assay; or just open to the upper ambience as an internal well is, and by contrary they can be experimented though experimental results thereof are deemed useless. The said sham wells are more preferred to be open to the upper ambience since this will help adjacent wells expose to a balanced air ventilating pattern comparable to others.

Apparently, the preferred embodiment 3 according to the present invention has some novel advantages. First of all, the sham wells are physically located on the way of the micro-wells sideward to the ambience and acting as a buffering barrier for heating and/or cooling, so as able to retard the sideward heat transmission. Hence, the peripheral thermal preference will be prevented more or less. Second of all, the sham wells permit any of the other mico-wells they encircled, either on the edge or in the center of the circle, to possess the same physical surroundings, bringing forth the same patterns of air ventilation, liquid evaporation, and light exposure. Third but not the last, the disparity of pressures and tensions which was haunting the edges and corners during manufacturing processes and which was considered to be the cause of bottom unevenness, especially unevenness at edges and corners, will instead affect sham wells area; and this will at least help the regular experimentable bottom area be less affected and evener. Thus, all these will prevent some of the peripheral artifacts and impart better reliability of the experimental results at peripheral wells, especially corner wells.

### Preferred Embodiment 4

Alternatively to the preferred embodiment 1 possessing a bottom elongation 13, a preferred embodiment 4 according to the present invention has a releasable undercover in addition to a conventional microplate, and the said undercover is used to cover the bottom of the microplate from underneath when needed, especially when a temperature change is expected. The purpose of this undercover is to make a tight closure over the lower ambience, including the non-experimental slots, and prevent the ambient air from refreshing into the non-experimental slots. The said undercover is preferably co-packaged with the microplate as an assembly; More preferably, the said undercover is a separately-cataloged universal undercover.

In an alternative preferred embodiment, the microplate according to the present invention is similar to, or even the same as, one of any conventional microplates, but co-packaged with a separate and/or affixed sheet informing microplate users of the artifacts of peripheral wells especially such as corner wells, the relative unreliability, and/or some predictable preventive ways thereof.

### OPERATION OF INVENTION

Manufacture of the preferred embodiments according to this invention is already a known art. In addition, comparative experiments are described in this chapter. The purpose of comparative experiments is to elucidate the existing differences between some particular columns and rows of micro-wells within a conventional microplate and the possible artifacts thereof, and also make comparisons between a preferred embodiment of the microplate according to the current invention and a conventional microplate. In order to realize this, three experiments, which are in common use in laboratories, were carried out based on some standard laboratory protocols. The influences of heating disparity, air ventilation, and light exposure were studied respectively.

The first experiment was designed to investigate the possibility of heating preference affecting the HRP catalysis in the peripheral wells. Both a conventional microplate (Nunc® MaxiSorp™; Rochester, N.Y.) and a preferred embodiment of the microplate according to the current invention were pre-cooled to 4° C. HRP (RDI; Flanders, N.J.; 1:5000 in ELISA carbonate coating buffer, 4° C., 100 μl per well) was used to coat micro-wells by 4° C. overnight incubation.

The micro-wells were then ashed by 4° C. 1× PBS (five times, 400 μl each time), followed by adding 4° C. TMB solution (Sigma, Saint Louis Mo.; 100 μl per well). Next the microplates were kept in a 37° C. ambience for 5, 10 minutes, then read at 650 nm immediately. Results were shown in Table 1.

TABLE 1

| Model | Position | OD at 650 nm (10 min) |
|---|---|---|
| Nunc ® MaxiSorp ™ | Peripheral wells | 2.496 ± 0.158 |
| | Internal wells | 2.274 ± 0.141 |
| Preferred embodiment 3 | Peripheral wells | 2.267 ± 0.144 |
| | Internal wells | 2.279 ± 0.134 |

The second experiment was designed to investigate the possibility of air ventilation affecting the cell cultures in the peripheral wells. Both a conventional microplate (Corning Incorporated Costar®; Corning, N.Y.) and a preferred embodiment of the microplate according to the current invention were used to host 37° C. Balb/c 3T3 cell cultures in 10% FBS containing DMEM in vitro. Universal lids were used to cover the plates during incubation. Balb/c 3T3 cells, starting at the same cell density in each well, consumed the media and eventually turned its color from pink to yellow. The time when the first batch media changed its color was recorded. Once all micro-wells changed color, media was refreshed into each micro-well. Media refreshments were repeated until most wells reach cell confluence. Cell cultures were finally subject to incorporation of Thiazolyl Blue Tetrazolium Blue (MTT; Sigma; Saint Louis, Mo.) followed by colorimetry at 570 nm. Results were shown in Table 2.

TABLE 2

| | | Time of media | |
|---|---|---|---|
| Model | Position | color change | OD at 570 nm |
| Costar ® microplate | Peripheral wells | 18 ± 0.4 hr | 1.547 ± 0.079 |
| | Internal wells | 26 ± 0.5 hr | 1.783 ± 0.098 |
| Preferred | Peripheral wells | 24 ± 0.5 hr | 1.794 ± 0.080 |
| embodiment 3 | Internal wells | 25 ± 0.4 hr | 1.839 ± 0.076 |

The third experiment was designed to investigate the possibility of light exposure affecting the actino-sensitive reaction in the peripheral wells. Both a conventional microplate (Corning Incorporated Costar®; Corning, N.Y.) and a preferred embodiment of the microplate according to the current invention were used to host the photochemical decomposition of the iron (III) complex generating iron (II) ions. Prepare accurately a 20 ml aqueous solution of 1 mg/ml anhydrous potassium tris(oxalato)ferrate (III). After mixing well, pipette a 10 mL aliquot into a 20 ml volumetric flask, and continue by adding 8 ml of acetic acid and sodium acetate buffer (pH 4.5), 1 ml of 2,2′-dipyridyl solution (0.32% in water, w/v) and make up to the mark with water. Mix well and aliquot 200 μl each into micro-wells. Expose the microwells to a bright light for 30 min, 60 min with swirling occasionally. And record the absorbance at 522 nm. Results were shown in Table 3.

TABLE 3

| Model | Position | OD at 522 nm (60 min) |
|---|---|---|
| Costar ® microplate | Peripheral wells | 1.257 ± 0.057 |
| | Internal wells | 1.378 ± 0.081 |
| Preferred embodiment 3 | Peripheral wells | 1.235 ± 0.065 |
| | Internal wells | 1.276 ± 0.074 |

### CONCLUSION, RAMIFICATIONS, AND SCOPE OF INVENTION

Thus the reader will see that at least one embodiment of the microplate provides a more reliable, less peripherally affected device that can be used in biomedical and chemical assays.

While my above description contains many specifics, these should not be construed as limitations on the scope of the invention, but rather as an exemplification of several preferred embodiments thereof. Many other modifications and variations of the present invention are possible in the light of the above teachings.

Accordingly, the scope of the invention should be determined not by the embodiments illustrated, but by the appended claims and their legal equivalents.

I claim:

1. A microplate, comprising:
(a) a plurality of micro-wells (3);
(b) said micro-wells further consisting of a plurality of peripheral wells (9) surrounding a plurality of internal wells (10), so that said peripheral wells are of surrounding disparity compared to said internal wells;
(c) the improvement comprising means of structure adaptation on peripheral areas for compensating said surrounding disparity of said peripheral wells;
whereby said peripheral wells can be deprived of peripheral artifacts associated with said surrounding disparity.

2. The microplate of claim 1, comprising:
(a) four side-walls (5) supporting said plurality of micro-wells
(b) an elongation (13) surrounding said plurality of micro-wells;
(d) the improvement wherein said elongation (13) enabling a closure of the space between said side-walls and said plurality of micro-wells from underneath;
whereby convective heat exchange within said non-experimental slots is prevented.

3. The microplate of claim 2, further comprising air-through notches (16) at said side-walls (5), whereby allowing air convection beneath said bottom.

4. The microplate of claim 2 wherein the shape of said microwell is chosen from a group consisting of flat bottom shape, round bottom shape, V bottom shape, conical bottom shape, pyramid bottom shape, and mixtures thereof.

5. The microplate of claim 2 wherein the thickness of side-wall (5) is increased to to two to four times of a predetermined wall thickness of said internal well; whereby heat transmission via side-walls is retarded

6. The microplate of claim 2 wherein a releasable layer is attached to said side walls (5).

7. A microplate of claim 6 wherein said layer is chosen from a group consisting of heatproof materials, soundproof materials, lightproof materials, post-casting treatment, and the like.

8. An alternative of the microplate of claim 2 wherein said elongation is replaced by a releasable undercover.

9. The microplate of claim 1, further comprising a plurality of sham wells (19) surrounding peripheral wells (9); so that said sham wells substantially compensate surrounding disparity of said peripheral wells (9).

10. The microplate of claim 9 wherein said sham wells (19) are designed for holding sham samples, so that said sham samples further compensate surrounding disparity of said peripheral wells (9).

11. The microplate of claim 9 wherein size of said sham well (19) is chosen from a group consisting of a bigger size, a similar size, or a smaller size compared to the size of an internal well (10).

12. The microplate of claim 9 wherein said sham wells (19) are equal in size to internal wells (10), so that substantially compensate said surrounding disparity of said peripheral wells.

13. An alternative to the microplate of claim 9, where in a plurality of sham wells (19) are said peripheral wells (9).

14. The microplate of claim 1 wherein said peripheral wells further comprising peripheral well-walls; characterized in that the thickness of said peripheral well-walls (12) is increased to two to four times of a predetermined thickness.

15. The microplate of claim 1 wherein said peripheral wells further comprising peripheral well-walls; characterized in that a releasable layer is attached to said peripheral well walls (12).

16. The microplate of claim 15 wherein said layer is chosen from a group consisting of heatproof materials, soundproof materials, lightproof materials, post-casting treatment, and the like.

17. A microplate comprising a plurality of microwells; the improvement wherein said microplate is co-packaging with an information sheet notifying users of the artifacts of peripheral wells and preventive ways thereof.

18. The microplate of claim 17 wherein said microplate is further co-packaged with a sticky layer for peripheral well walls and/or side-walls; and the material of said layer is chosen from a group consisting of heatproof materials, soundproof materials, lightproof materials, post-casting treatment, and the like.
